(19) United States
(12) Patent Application Publication
(10) Pub. No.: US 2014/0346959 A1
(43) Pub. Date: Nov. 27, 2014

(54) Circuit Arrangement and Method for Operating an LED Chain on AC Voltage

(71) Applicant: Marcel-Breuer-Strasse 6, München (DE)

(72) Inventors: Hubert Maiwald, Neutraubling (DE); Robert Kraus, Regensburg (DE)

(21) Appl. No.: 14/365,500

(22) PCT Filed: Dec. 7, 2012
(86) PCT No.: PCT/EP2012/074753

§ 371 Date: Jun. 13, 2014

(30) Foreign Application Priority Data
Dec. 13, 2011 (DE) 10 2011 088 407.6

(51) Int. Cl. H05B 33/08

(52) U.S. Cl. CPC H05B 33/0812
USPC 315/185 R

(57) ABSTRACT

A circuit arrangement for operating a chain comprising at least one light emitting diode on an AC voltage, in particular mains voltage, comprising a rectifier with an input circuit for drawing the AC voltage and an output circuit, into which a rectified AC voltage is output. An energy store is provided in the output circuit, in particular a storage capacitor, to which the LED chain can be connected in a parallel circuit. A current controller interrupts, during operation, the charging of the storage capacitor each time the current in the output circuit has risen to a specific threshold current, and enables charging again when the voltage in the output circuit has then fallen to a specific threshold voltage.

The invention relates to circuit arrangements for operating a chain comprising at least one light-emitting diode (LED) (LED chain) on an AC voltage. The invention also relates to lighting apparatuses comprising such a circuit. In addition, the invention relates to a method for operating an LED chain and a lighting apparatus comprising such a circuit arrangement and an LED chain.

If the intention is for LEDs to be operated directly on an AC voltage with a predetermined level, for example on the mains, either the voltage needs to be converted or the LED chain needs to be designed in such a way that its forward voltage is in the region of the supply voltage. In the latter case, apart from controllers which are switched at high frequencies, there are two variants: the LED chain is either connected directly to the mains via a (current-limiting) series resistor (so-called AC LEDs) or power is supplied to the LED chain via a linear series regulator, wherein the rectified voltage is smoothed in advance by a capacitor.

In the first variant, it is disadvantageous that the LEDs flicker at twice the mains frequency and output light in less than half the time.

The second variant also has its specific disadvantages: the absorption currents of the capacitors are very high in comparison with the operating current. In addition, capacitors and rectifiers are overloaded during switchon since the switchon

time at the mains is not defined. Finally, the power loss in the controller is very high when the circuit is designed such that it is intended to withstand the total mains tolerances.

In order to diminish the disadvantages outlined, a not inconsiderable amount of complexity in terms of circuitry is required. For example, if it is desired to damp the flicker, energy-storing components need to be added or brightness modulations which are no longer visible to the eye need to be generated. Often, therefore, remedial measures are not taken and the existing defects are just accepted.

The object of the present invention consists in overcoming the disadvantages of the known solutions and in particular in specifying a circuit arrangement of the type mentioned at the outset which has a particularly simple and robust design, achieves good levels of efficiency in the process, is also only loaded slightly more in the critical switchon phase than in the steady-state phase, tolerates unavoidable mains fluctuations and/or not least can generate a light which is flicker-free to the eye.

The object is achieved by a circuit arrangement for operating a chain (LED chain) comprising at least one light-emitting diode on an AC voltage, said circuit arrangement comprising
a rectifier with a circuit (“input circuit”) for drawing the non-rectified AC voltage and a circuit (“output circuit”) into which the rectified AC voltage is output,
an energy store provided in the output circuit (i.e. connected downstream of the rectifier), in particular energy-storing capacitor (“storage capacitor”),
to which the LED chain can be connected in a parallel circuit,
a current controller, which, during operation, interrupts the charging of the storage capacitor each time the current in the output circuit has risen to a specific maximum value (“threshold current”) and enables charging again when the voltage in the output circuit has then fallen to a specific value (“threshold voltage”).

In the present context, the charging operation is considered to be interrupted when the current in the output circuit has decreased significantly, i.e. is clearly below 10%, preferably below 5% and particularly preferably below 2% of the threshold current. Apart from this, the values for the threshold current and/or the threshold voltage can be fixedly predetermined or adjusted.

The elements of the circuit arrangement which are arranged in the input circuit are therefore connected upstream of the rectifier, and the elements of the circuit arrangement which are arranged in the output circuit are connected downstream of the rectifier.

The mode of operation of the proposed circuit arrangement is based on the following basic principle: the capacitor used acts as an energy store. It is charged until a threshold current is reached. During the charge phase, the current flows into the storage capacitor and through the LED chain. If the threshold value has been reached, the capacitor charging current is drastically reduced, with the consequence that the capacitor is discharged again. In the discharge phase, the charge is conducted into the LED chain. Current limitation in this phase can be dispensed with since the current results from the, already limited, peak current in the respective previous charge phase. To

this extent, the current controller operates as a charge balance controller, strictly speaking.

Such a principle provides a series of advantages:
the inrush current peak is lower than in the case of the variant of rectifier and mains capacitor with a level which is independent of the switchon time and of a defined level. Therefore, the proposed circuit arrangement can also be used in many of these systems.
The efficiency is likewise better in comparison with solutions with a rectifier and a charging capacitor.
The charge quantity drawn within a half-cycle is approximately identical, as is also the charge quantity output to the LEDs. Therefore, the LED current, apart from its residual ripple brought about by the charging and discharging, also remains substantially constant.
The current residual ripple is relatively low, and therefore disruptive flicker can be avoided.
The complexity in terms of components is conceivably low; in particular no transformers or inductances are required. Correspondingly, the circuit arrangement and the LED chain can be accommodated in particular on a common printed circuit board, to be precise in particular on one side, with the result that convenient cooling is enabled and, in this way, the lighting module is provided with a particularly simple configuration.
The arrangement is very tolerant: thus, the voltage frequency could be, for example, both 50 Hz and 60 Hz, and the voltage level can fluctuate within relatively wide limits. Relatively large fluctuations in capacitance, changes in operating temperature and scatter in the LED characteristic data are also readily tolerated and under certain circumstances even compensated for. Even if one of the
light-emitting diodes were to fail, this would not have a disadvantageous effect, in any case in terms of the voltage.

The circuit arrangement is suitable in particular for a supply voltage from the mains, but other AC voltage sources can also be used. Irrespective of the selection of the voltage source, it is recommended to apply the threshold voltage to the zero crossing, but this value is not essential either.

Preferably, the circuit arrangement is dimensioned such that the forward voltage (rated voltage) of the LED chain Ufges is 0.5 Vcc<UFges<0.9 Vcc. In particular, 0.6 Vcc<Ufges<0.8 Vcc can hold true, and in particular 0.65 Vcc<Ufges<0.75 Vcc. In this case, Vcc=Umin*1.41 (Umin is the minimum rms value of the drawn AC voltage and Vcc is the peak value thereof; for the rated voltage of the LED chain, Ufges=Uf*N, where Uf=rated voltage or forward voltage of the individual LEDs and N=number of LEDs in the chain). Therefore, a particularly expedient range of between 140 V and 250 V results given a Umin of 200 V for Ufges. In this case, it is necessary to consider that at relatively low rated voltages the efficiency decreases, but at the same time the sensitivity to AC voltage changes also decreases; the reverse is true at relatively high rated voltages.

Preferably, for the threshold current 1.5 Iled<Ipeak<4 Iled holds true, where Iled is the rated current of the individual LEDs and Ipeak is the threshold current. At Ipeak values below 1.5 Iled, the capacitor would possibly only be charged insufficiently; at Ipeak values above 4 Iled, possibly higher losses and peak currents would have to be accepted.

In a preferred configuration, the current controller comprises a control element which is connected in series, in the output circuit, with the parallel circuit formed from the storage capacitor and the LED chain and which transfers from a low-resistance state to a high-resistance state when the threshold current is reached and returns to the low-resistance state when the threshold voltage is reached.

In a particularly preferred configuration, the control element comprises two branches which are parallel to one another in the output circuit of the rectifier and of which one branch (first branch) is conducting in the low-resistance state of the control element and is off in the high-resistance state, and the other branch (second branch) is off in the low-resistance state and is conducting in the high-resistance state. In the simplest case, the first branch contains a switch (first switch) in series with a low-resistance resistor, and the second branch contains a high-resistance resistor, likewise in series with a switch. If, for example, a bipolar transistor is used as the first switch, in particular a thyristor is appropriate as the second switch. If, on the other hand, a MOSFET is used as the first switch, in particular a bipolar transistor is suitable as a second switch. Preferably, the low-resistance and the high-resistance resistor, given the switch pairing of the transistor/thyristor, are on the emitter side of the transistor or in the collector-base circuit thereof, and the gate of the thyristor which is connected downstream of the high-resistance resistor is passed to the first branch between the emitter of the switching transistor and the low-resistance resistor.

Preferably, the high-resistance resistor has such a high resistance value that, in the case of interrupted charging of the

capacitor, at most 10% of the rated current of the LEDs can flow. If the combination transistor/thrysistor is used, the resistor can in particular be dimensioned such that it provides the base current for the switching transistor in the charge phase and, in the phase of charge interruption, ensures that the holding current of the thyristor is not undershot. This results in values which are typically between 5 kΩ and 20 kΩ.

The low-resistance resistor, which determines the threshold current via the relationship Rno=Uth/Ipeak (where Rno is the resistance value of the low-resistance resistor and Uth is the thyristor gate trigger voltage), is preferably dimensioned such that this current value is in the abovementioned range of between 1.5 times and 4 times the rated LED current.

The switch in the first branch is in particular designed in such a way that it tolerates the maximum rectified operating voltage and the threshold current and, for a short period of time, also the rated power resulting from the product of both variables.

The switch in the second branch withstands in particular the maximum rectified operating voltage; a thyristor should preferably require a holding current of <0.1 rated LED current.

Preferably, the capacitance of the storage capacitor is between 100 and 1000 μF per ampere of the LED rated current, i.e. between 2 and 20 μF given a rated LED current of 20 mA. High values reduce the residual ripple, and low values reduce the switchon time. The storage capacitor can be a simple electrolytic capacitor because it is charged and discharged

in a controlled manner and there is no dependency on a specific radio frequency response.

No particular requirements are imposed on the rectifier of the circuit arrangement. It merely needs to be designed for the threshold current and the operating voltage.

If the low-resistance resistor of the current controller has a fixed value, the threshold current is preferably likewise fixedly predetermined, i.e. the LED current is subjected to indirect closed-loop control. Depending on the design of the LED chain, in particular either the efficiency or the control stability can then be optimized. If a high level of control stability is desired with at the same time a high level of efficiency, the circuit arrangement can in particular be developed by introducing direct closed-loop control of the current flowing through the LED chain.

In a particularly simple manner, such direct closed-loop LED current control is achieved by integration of the following functions: detection and filtering of the LED current, communication of the filtered current value as actual variable to a control stage and comparison of the actual variable in this stage with a setpoint variable for forming a manipulated variable which acts on a changeable low-resistance resistor such that the LED current is less sensitive to mains voltage fluctuations, for example.

If the circuit arrangement is provided with the additional control loop mentioned, it is recommended to configure and design the elements thereof as follows:

For the current detection, the voltage is tapped off across an ohmic resistor which is downstream of the LED chain. This resistor is dimensioned such that, at the same time, the losses are as low as possible and the signal becomes as great as possible; its value is accordingly typically in the ohms range, preferably between 0.5 and 15Ω.

Current detection and filtering are normally, but not necessarily, combined to form a function block. This block needs to have a differential input which tolerates the high voltages occurring. The filtering should, as far as possible, suppress the current ripple; its low-pass limit frequency should preferably be lower than the frequency of the AC voltage source.

The control stage receives its setpoint value via a reference voltage source. Said reference voltage source should preferably be configured in such a way that the system does not oscillate in the switchon phase either. Particularly suitable for the present purposes is a PI controller which is sufficiently accurate and transfers sufficiently quickly.

The actuating element can be adjusted particularly easily to a design in which the current regulator contains a control element comprising a first branch formed from a switch in series with a low-resistance resistor and a second branch formed from a high-resistance resistor in series with a further switch. In this case, a path comprising a switch, preferably a MOSFET, in series with a further fixed-value resistor can be connected in parallel with the low-resistance resistor, and the manipulated variable output by the control stage can act on the switch. With this configuration, the low-resistance resistor in the first branch of the control element should be designed such that the rated LED current is reached at the minimum operating voltage and maximum LED chain voltage. The series resistor with respect to the switch should preferably be designed in such a way that the rated

LED current is achieved at the maximum operating voltage and minimum LED chain voltage in the parallel circuit comprising the two resistors and the switch; the series resistor with respect to the switch conventionally has a value which is at least as great as the resistance in the first control element branch.

The operating voltage for the control stage and the upstream function block and also the supply of the reference voltage can conveniently be produced by peak value rectification at the input of the control element.

If the circuit arrangement contains the control loop illustrated, in this branch so-called thermal derating could be realized still without any considerable additional complexity. As is known, the failure rate in the case of components increases as the operating temperature increases and, in order to counteract this, the setpoint current value could easily be reduced with a suitable dependency on the temperature, for example.

Moreover, the control loop in no way necessarily needs to adjust the LED current directly. It is also quite possible for other controlled variables, in particular the averaged AC voltage at the rectifier input, to be used. Even in such cases, high efficiencies can be linked with a good LED current stabilization.

Irrespective of whether an additional control loop is installed or not, the circuit arrangement can be configured, within the scope of the invention, in such a way that the output light is dimmable within certain limits. For this, in a manner known per se, pulse width modulation, in particular phase gating control, can be used. In order in this case to compensate for the reactive power, it is recommended to use

a low-pass filter in the form of an RC element in the input circuit, preferably with values of the order of magnitude of 100Ω and 0.1 μF, respectively.

In general, any other suitable energy store can also be used instead of a capacitor, for example a rechargeable battery.

The object is also achieved by a lighting apparatus, in which a circuit arrangement of the proposed type is interconnected with an LED chain. As already mentioned, this apparatus, owing to the simple and space-saving circuit arrangement, can in Particular be configured in a very compact and inexpensive manner with a printed circuit board which is populated in particular on the front and cooled on the rear.

In addition, the object is achieved by a method for operating an LED chain comprising at least one light-emitting diode on an AC voltage, which method contains at least the following steps:
The AC voltage is rectified,
a capacitor (storage capacitor) which is connected in parallel with the LED chain in the circuit of the rectified AC voltage (output circuit) is charged by the rectified AC voltage until a specific maximum current value (threshold value) is reached and then is discharged until a specific minimum voltage value (threshold voltage) is reached, wherein, in the steady state,
during the charge phase current flows both through the storage capacitor and through the LED chain and,
in the discharge phase the charge of the storage capacitor is conducted into the LED chain.

The invention will be explained in more detail schematically below with reference to three exemplary embodiments illustrated in the drawing. Identical components have in this case been provided with the same reference symbols. In the drawing:

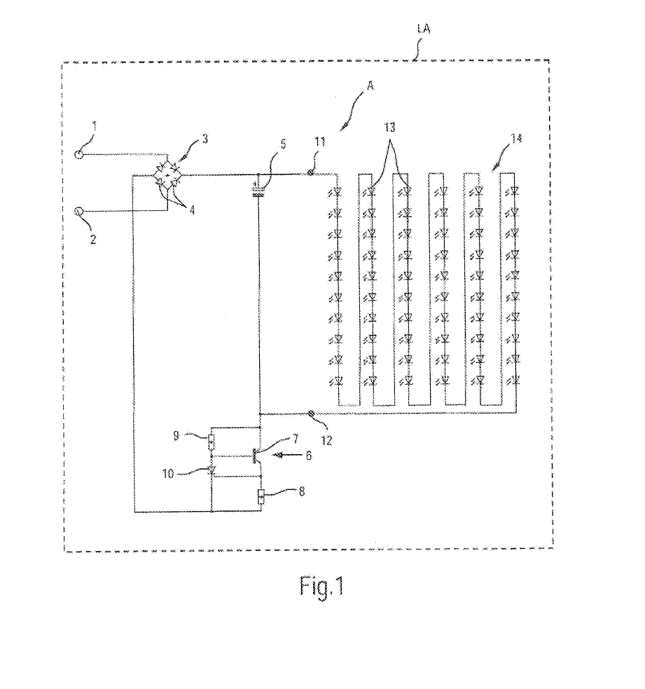

FIG. 1 shows the circuit diagram of a first exemplary embodiment of a lighting apparatus according to the invention,

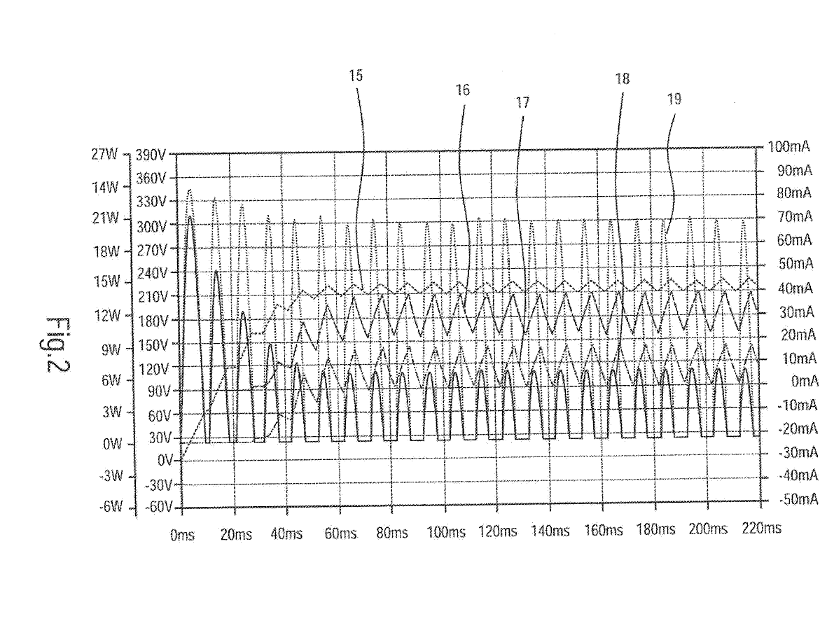

FIG. 2 shows calculated current, voltage and power curves after switchon of the circuit arrangement of the apparatus shown in FIG. 1,

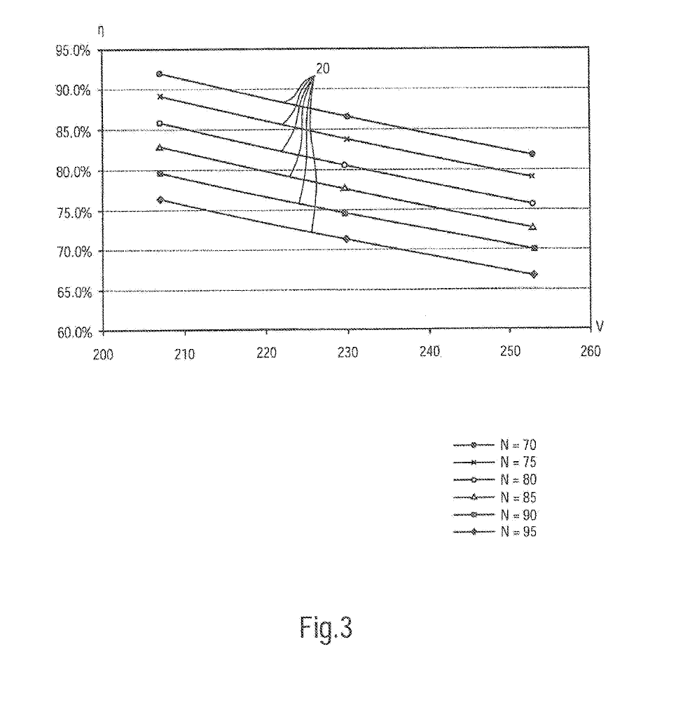

FIG. 3 shows the calculated efficiency of the apparatus shown in FIG. 1, as a function of the mains voltage, to be precise for a different number of LEDs,

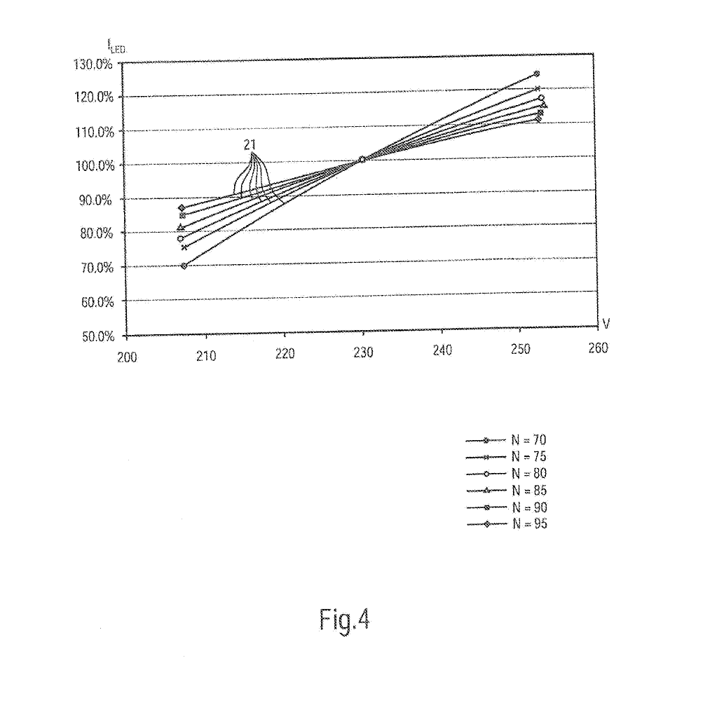

FIG. 4 shows the calculated LED current in an apparatus as shown in FIG. 1, likewise as a function of the mains voltage and for a different number of LEDs,

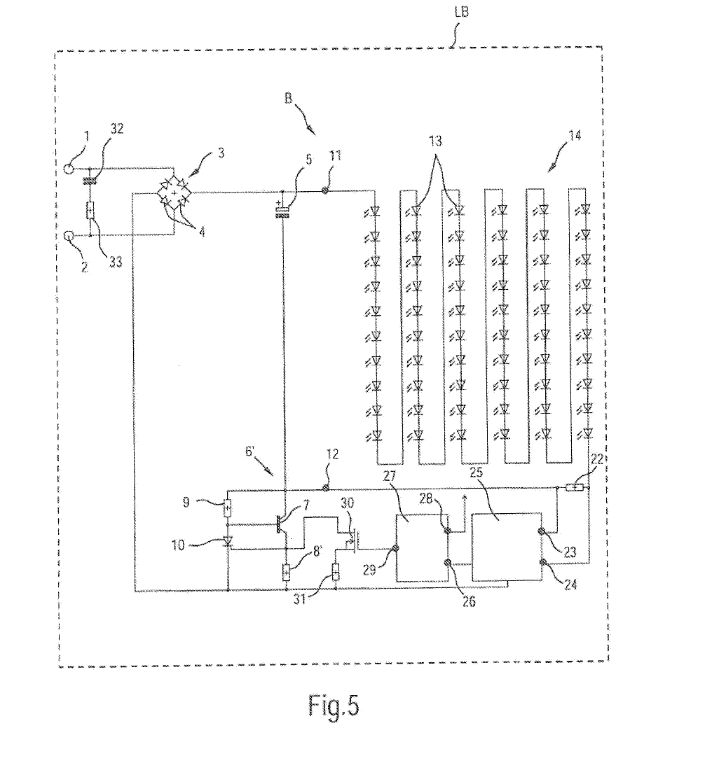

FIG. 5 shows the circuit diagram of a second exemplary embodiment, and

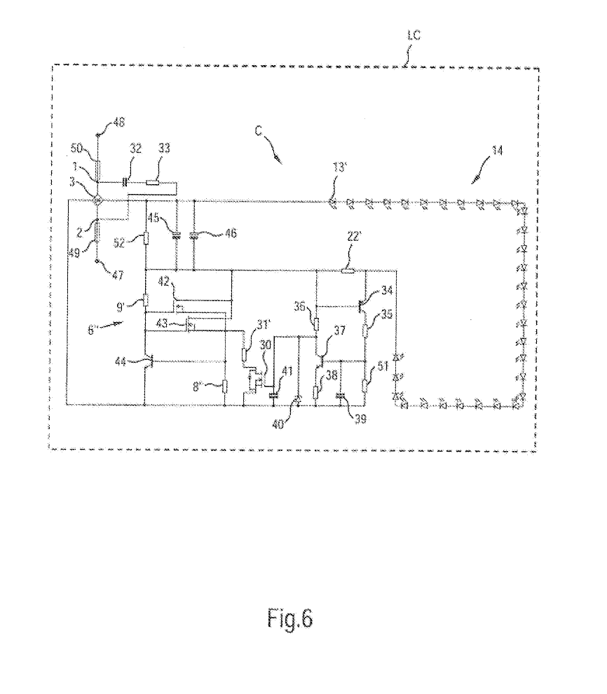

FIG. 6 shows the circuit diagram of a third exemplary embodiment.

A circuit arrangement A of a lighting apparatus LA shown in FIG. 1 has an input with two input connections 1 and 2, to which an AC supply voltage, in the present case a mains voltage of 230 V, can be applied. The drawn AC voltage is converted in a rectifier 3, in this case a bridge rectifier formed from four diodes 4, to give a pulsating DC voltage. An input circuit 1, 2 is in this case therefore formed by the two input connections 1 and 2.

A storage capacitor 5 in the form of an electrolytic capacitor in the region of 10 μF is connected in series with a current controller 6

in the circuit of the pulsating DC voltage (output circuit). The current controller 6 contains two branches which are parallel to one another in the output circuit. One branch comprises, as switch, a bipolar transistor 7, by way of example, and a low-resistance resistor 8 (first resistor) with a value in the region of 10Ω (low-resistance branch). The bipolar transistor 7 is connected on the collector side to the storage capacitor 5 and on the emitter side to the resistor 8. The second branch contains, in series with one another, a high-resistance resistor 9 (second resistor) with a resistance value in the region of 10 kΩ and a thyristor 10 (high-resistance branch). The resistor 9 is in this case in the base-collector circuit of the bipolar transistor 7, while the thyristor 10 is connected between the base of the bipolar transistor 7 and that side of the resistor 8 which is remote from the bipolar transistor 7. The thyristor gate is guided onto the first branch between the emitter of the bipolar transistor 7 and the resistor 8. Two output connections 11 and 12, which are present upstream of or downstream of the storage capacitor 5, form the output of the circuit arrangement A.

An LED chain 14 formed from individual light-emitting diodes 13 connected in series with one another is connected to these output connections 11 and 12 with the polarization illustrated. The individual light-emitting diodes 13 have a rated voltage of approximately 3.3 V and a rated current of approximately 20 mA. The entire LED chain 14 has a forward voltage of approximately 200 V.

The output circuit 5-12 is in this case therefore formed by the elements connected downstream of the rectifier 3 up to and including the output connections 11 and 12.

The circuit arrangement A in this case functions as follows: At initial startup, the storage capacitor 5 is initially empty. Over the course of the first half-cycle of the rectified mains voltage, the storage capacitor 5 is charged until the threshold current that can be adjusted via the resistor 8 is reached. Then, the gate trigger voltage for the thyristor 10 is present as a voltage drop across the resistor 8 (in this case: 0.65 V). Therefore, the thyristor 10 is triggered and the bipolar transistor 7 is turned off. The current now flows through the high-resistance branch 9, 10 instead of through the low-resistance branch 7, 8 and is so low that no further charging occurs. At the next zero crossing of the rectified. AC voltage, the thyristor 10 is turned off again, i.e. the low-resistance branch 7, 8 of the current controller 6 becomes conducting again owing to the closing of the bipolar transistor 7; at the same time the high-resistance branch 9, 10 is off. Therefore, the charging can begin again. The entire procedure is repeated until the voltage across the storage capacitor 5 comes to be in the region of the forward voltage of the LED chain 14 (approximately 200 V). Then, the steady-state, cyclic operation begins. In this case, during charging, some of the current then flows into the storage capacitor 5, and the rest of the current flows through the LED chain 14 until the threshold current is reached again. Two effects are achieved by the disconnection: the current through the storage capacitor 5 and therefore the current consumption of the entire circuit is limited. In addition, the charge quantity absorbed into the storage capacitor 5 is always approximately the same, as a result of which the discharge current remains more or less constant.

In order to further clarify the described operational performance, FIG. 2 illustrates characteristic current, voltage and power curves determined on the basis of a simulation as time profiles from the switchon time. In

the graph, the curve 15 shows the voltage increase at the LED chain 14 after switchon, the curve 16 shows the current in the LED chain 14, the curve 17 shows the power consumed by the LED chain 14, the curve 18 shows the losses in the current controller 6, and the curve 19 shows the total power consumption. It can be seen that the circuit arrangement transfers to stable operation after switchon over the course of a few half-cycles. The voltage across the LED chain 14 first increases until it has reached its full value after approximately 60 ms, about which value it then fluctuates with a very low residual ripple (curve 15). As can be seen from curve 16, the current through the LED chain 14 first begins to flow after approximately 30 ms and reaches its rated value after the same number of half-cycles as the voltage. In the settled state, the current fluctuates synchronously in time with the voltage about its mean value, naturally with a relatively large amount of travel owing to the overlinear current/voltage characteristic, but with this travel percentagewise always being much smaller than the change in the mains voltage. The LED power of the product of the voltage and the current of the LED chain 14 follows the two curves 15 and 16, to be precise with modulation influenced by the current residual ripple (curve 17). As can be seen from curve 18, the circuit arrangement A begins with a relatively high, but in total quite limited controller losses, which decrease over the course of the transient condition and, in the steady state in which no power at all is consumed in the controller during approximately half the time, are decidedly moderate. A comparison with curve 19 shows that the power consumed in the control element during steady-state operation only has a comparatively low proportion of the power consumed in total. This power is moreover barely higher in the switchon phase than in the steady-state phase. With the circuit arrangement illustrated, efficiencies of up to 85% can be achieved.

FIG. 3 illustrates how the efficiency η is dependent specifically on the mains voltage V and the number N of LEDs used. Given a specific number of LEDs, it decreases linearly with increasing voltage (curve 20). If the number of LEDs, which in the present computation example have a forward voltage of 2.9 V, is increased from 70 to 95, the efficiency increases, on the other hand. Thus, a family of mutually parallel straight lines results. At a mains voltage of 230 V, an efficiency of 85% is achieved in the calculated example with a chain comprising 92 LEDS.

FIG. 4 shows, again for a different number of LEDs, how the current I_{LED}, in this case represented as a percentage of the rated LED current, is dependent on the mains voltage. It can be seen from curves 21 that the actual current increases linearly with increase in voltage, wherein the straight lines become steeper as the number of LEDs increases; the straight lines intersect one another at 230 V. In other words: if the LED chain is made longer, within certain limits, firstly the efficiency increases and secondly the LED current also has a more sensitive response to voltage fluctuations, however.

Naturally, the light output of the LEDs is also dependent on further variables, for example the operating temperature. This dependency is in this case reduced, however, since other components such as the bipolar transistor 7 have a compensating temperature drift.

In the exemplary embodiment of the lighting apparatus LB shown in FIG. 5 which has a slightly more complex configuration, the LED current is additionally stabilized, to be precise by direct closed-loop control of the LED current. This embodiment has a

circuit arrangement B, which is different from the circuit arrangement A illustrated in FIG. 1 substantially in that the current controller contains a control element 6′ supplemented by an additional control loop. For this purpose, the voltage is tapped off across a resistor 22 (third resistor) inserted into the LED branch downstream of the chain 14, said resistor having the variable 1Ω, and is passed to the inputs 23, 24 of a function block 25. This block detects the LED current, suppresses the current ripple by means of filtering and passes on a signal corresponding to the averaged current, as actual value, to a first input 26 of a PI controller 27, which forms the setpoint value from a reference voltage supplied by a voltage source and passed to a further input 28. The difference signal formed by a setpoint/actual value comparison is passed onto the gate of a MOSFET 30. The MOSFET is connected in series with a source-side low-resistance resistor 31 (fourth resistor). The first resistor 8′ and the fourth resistor 31 are equal in size, in the present case, namely 20Ω; that is twice the value of the first resistor 8 in the first exemplary embodiment. The resistance Rds(on) of the MOSFET in the conducting state (it is predominantly operated in the small signal range) is below 1Ω. The resistance network formed from the elements 8′, 30 and 31 therefore has a value range which is sufficient for the closed-loop control.

In addition, a capacitor 32 with a capacitance of approximately 100 nF is connected in series with a fifth resistor 33, with a value of approximately 100Ω, in the input circuit of the rectifier 3. This RC element is used for compensating for reactive powers resulting.

During operation, the LED current is adjusted to the rated current via the variable total resistance formed from the components 8′, 30 and 31 and thus, with a predetermined gate trigger voltage of the thyristor 10, via the level of the threshold current.

FIG. 6 shows a lighting apparatus LC in accordance with a third exemplary embodiment, specifically the circuit arrangement C. This circuit arrangement C has an efficiency of ≧87% with a chain comprising 32 LED units 13° with forward voltages of around 8.8 V. In addition, the LED current is stabilized, to be precise in turn by direct LED current measurement in an extended control element 6″.

For this direct closed-loop control, the LED current is taken off at a third resistor 22′, which in this case has a resistance value of 8Ω. That end of the third resistor 22′ which is on the LED chain side (first end) is connected, via the emitter-collector path of a pnp transistor 34 in series with a sixth resistor 35 (22 kΩ) and a seventh resistor 51 (10 kΩ), to the negative output of the rectifier 3. The second end of the third resistor 22′ is routed via an eighth resistor 36 (100 kΩ), the collector-emitter path of an npn transistor 37 and a ninth resistor 38 (2 kΩ), likewise to the negative output of the rectifier 3. The base of the transistor 34 is connected to the second end of the resistor 22′, while the base of the transistor 37 is routed between the resistors 35 and 51. Moreover, another capacitor 39 (10 μF) is connected between the base of the transistor 37 and the negative output of the rectifier 3. A zener diode 40 and a capacitor 41 (2 nF) are connected in parallel with the chain formed from the collector-emitter path of the transistor 37 and the resistor 38.

The gate of the MOSFET 30 is on that side of the capacitor 41 which is remote from the negative output of the rectifier

3. The source-drain path of this transistor is in series with a resistor 31′ with a value of 3Ω, and this series in turn is in parallel with the first resistor 8″, which in the present case has a value of only 5Ω. The switch in the first current controller branch this time, for thermal reasons, comprises two MOSFETs 42, 43, which are in parallel with one another. These MOSFETs moreover do not need to be connected next to one another; thus, for example, the gate of the MOSFET 43 could also be routed via a dedicated resistor to the negative output of the rectifier 3. The gates of the two MOSFETs 42, 43 are connected between the high-resistance resistor 9′ (47 kΩ) and the collector-emitter path of the switch, in the present case a pnp transistor 44. The base of this transistor is routed between the MOSFET 43 and the low-resistance resistor 8″.

For space reasons, the charging capacitor comprises two electrolytic capacitors 45, 46 which are in parallel with one another and are equal in size. A tenth resistor 52 with a very high resistance (1 MΩ) is connected in parallel with this assembled capacitor and ensures that the electrolytic capacitors are discharged gently after disconnection.

In each case SMD fuses 49, 50 are also located between the inputs 1 and 2 of the circuit arrangement C and the actual connections of the printed circuit hoard (pads 47, 48), as can be seen in FIG. 6.

During operation of the circuit arrangement C, a voltage corresponding to the LED current is tapped off across the resistor 22′, smoothed by the components 35, 51 and 39 and inverted by the components 36, 37 and 38 (and furthermore also subjected to closed-loop control). The zener diode 40 ensures that in the switchon

phase, voltage peaks are chopped. The capacitor 41 assists in the gate voltage of the MOSFET 30 fluctuating between 0.7 and 3 V.

Measurements show that the energy consumption of the apparatus remains virtually constant (power factors of 0.8, 0.84 and 0.89 at input voltages of 200, 230 and 255 V, respectively) even in the case of relatively large fluctuations in the AC input voltage, for example in the range 230+/−30 V.

The present invention is of course not restricted to the exemplary embodiments illustrated.

When it is primarily only an issue of the capacitor being charged in a controlled manner and discharged again directly via the LED chain, the freedom in terms of the configuration is particularly great. Thus, the current controller of the circuit arrangement, even if it is in the form of a parallel circuit comprising two branches, switched so as to be conducting alternately, in an impressively simple and elegant manner, could be realized in another way as well. Identical functions, i.e. the detection of controlled variables, the disconnection when a defined charge/LED current value is reached or reactivation of the current source when subsequently passing the threshold voltage value, can be simulated in a manner known per se even with a slightly more complex circuit, in which, for example, a microcontroller detects the current. Irrespective of this, the light-emitting diodes could also emit at frequencies other than in the visible spectrum, for example in the IR or UV range, be embodied as OLEDs or extended, for example, to form arrays of chains connected in parallel.

### LIST OF REFERENCE SYMBOLS

1 First input connection
2 Second input connection
3 Rectifier
4 Rectifier diodes
5 Storage capacitor
6,6′,6″ Control element in the first, second and third exemplary embodiment
7 Bipolar transistor
8,8′,8″ First resistor in the first, second and third exemplary embodiment
9,9′ Second resistor in the first and third exemplary embodiment
10 Thyristor
11 First output connection
12 Second output connection
13,13′ Light-emitting diode in the first and third exemplary embodiment
14 LED chain
15 Time profile of the voltage at the LED chain after switchon
16 Time profile of the current in the LED chain after switchon
17 Time profile of the power consumed by the LED chain after switchon
18 Time profile of the controller losses after switchon
19 Time profile of the total power consumption after switchon
20 Current in the LED chain as a function of the mains voltage, for a different number of LEDs
21 Efficiency as a function of the mains voltage, likewise for a different number of LEDs
22,22′ Third resistor in the second and third exemplary embodiment
23 First input of the function block 25
24 Second input of the function block 25
25 Function block for detecting and filtering the current in the LED chain
26 First input of the control stage 27
27 Control stage for generating the actuating signal
28 Second input of the control stage
29 Output of the control stage
30 MOSFET
31,31 Fourth resistor in the second and third exemplary embodiment
32 Capacitor
33 Fifth resistor
34 pnp transistor
35 Sixth resistor
36 Eighth resistor
37 npn transistor
38 Ninth resistor
39 Capacitor
40 Zener diode
41 Capacitor
42 MOSFET
43 MOSFET
44 pnp transistor
45 Electrolytic capacitor
46 Electrolytic capacitor
47 Pad
48 Pad
49 SMD fuse
50 SMD fuse
51 Seventh resistor
52 Tenth resistor
A Circuit arrangement of the first exemplary embodiment
B Circuit arrangement of the second exemplary embodiment
C Circuit arrangement of the third exemplary embodiment
LA Lighting apparatus comprising circuit arrangement A
LB Lighting apparatus comprising circuit arrangement B
LC Lighting apparatus comprising circuit arrangement C

1. A circuit arrangement for operating a chain comprising at least one light emitting diode on an AC voltage, in particular mains voltage, comprising:
a rectifier with an input circuit for drawing the AC voltage and an output circuit, into which a rectified AC voltage is output;
an energy store provided in the output circuit, in particular storage capacitor, to which the LED chain can be connected in a parallel circuit; and
a current controller, which, during operation, interrupts the charging of the storage capacitor each time the current in the output circuit has risen to a specific threshold current and enables charging again when the voltage in the output circuit has then fallen to a specific threshold voltage.

2. The circuit arrangement as claimed in claim 1, wherein the LED chain has a forward voltage, for which 0.5 Vcc<Ufges<0.9 Vcc holds true.

3. The circuit arrangement as claimed in claim 1, wherein 1.5 Iled<Ipeak<4 Iled, where Iled=rated current of the individual LEDs and Ipeak=threshold current.

4. The circuit arrangement as claimed in claim 1, wherein the current controller is a control element, which is connected in series, in the output circuit, with the parallel circuit formed from the storage capacitor and the LED chain and, during charging of the storage capacitor transfers from a low resistance state to a high resistance state when the threshold current is reached and, when the voltage in the output circuit has fallen to the threshold voltage, returns from the high resistance state to the low resistance state again.

5. The circuit arrangement as claimed in claim 4, wherein the control element contains two branches which are in parallel with one another in the output circuit, of which branches a first branch is conducting in the low resistance state and is off in the high resistance state, and a second branch is off in the low resistance state and is conducting in the high-resistance state.

6. The circuit arrangement as claimed in claim 5, wherein the first branch contains a first switch in series with a low resistance resistor, and the second branch contains a high-resistance resistor in series with a second switch.

7. The circuit arrangement as claimed in claim 4, wherein, in the high resistance state of the control element, a current of at most 10% of the rated current of the LED chain flows in the output circuit.

8. The circuit arrangement as claimed in claim 1, wherein the storage capacitor has a capacitance of between 100 μF and 1000 μF per ampere of the rated current of the LED chain.

9. The circuit arrangement as claimed in claim 1, which contains a phase gating control unit for dimming purposes and an RC element is inserted into the input circuit of said phase gating control unit.

10. The circuit arrangement as claimed in claim 1, wherein the current controller contains an additional control loop used for the closed loop control of the current flowing through the LED chain (LED current) by detection of the averaged AC voltage in the input circuit of the rectifier.

11. A lighting apparatus comprising a circuit arrangement as claimed in claim 10 and an LED chain connected to the circuit arrangement, wherein the current controller contains an additional control loop which is used for closed loop control of the current flowing through the LED chain (LED current) by detection of the LED current.

12. The lighting apparatus as claimed in claim 11, comprising means which detect and filter the LED current, subject the mean value obtained by filtering to a setpoint/actual value comparison and, using the difference signal obtained by the comparison, adjust the level of the threshold current to the LED rated current.

13. The lighting apparatus as claimed in claim 11, comprising means for reducing the setpoint value depending on the operating temperature.

14. A lighting apparatus comprising a circuit arrangement as claimed in claim 1, wherein the circuit arrangement together with the LED chain, is accommodated on a printed circuit board.

15. A method for operating an LED chain comprising at least one light emitting diode on an AC voltage, wherein
the AC voltage is rectified,
an energy store, in particular capacitor, which is in parallel with the LED chain in an output circuit of the rectified AC voltage, is charged with the rectified AC voltage until a maximum threshold current is reached and is then discharged until a minimum threshold voltage is reached, wherein
during steady state operation, current flows both through the energy store and through the LED chain during the charge phase, and
in the discharge phase, the charge of the energy store is conducted into the LED chain.

16. The circuit arrangement as claimed in claim 1, wherein the LED chain has a forward voltage, for which 0.65 Vcc<Ufges<0.75 Vcc holds true.

17. The circuit arrangement as claimed in claim 1, wherein 2 Iled<Ipeak<3 Iled, where Iled=rated current of the individual LEDs and Ipeak=threshold current.

18. The circuit arrangement as claimed in claim 1, wherein the storage capacitor is an electrolytic capacitor.

19. A lighting apparatus comprising a circuit arrangement as claimed in claim 1, wherein the circuit arrangement, together with the LED chain, is accommodated on one of the two sides of a printed circuit board.

20. The circuit arrangement as claimed in claim 1, wherein said specific threshold voltage is OV.
